(19) United States
(12) Patent Application Publication
(10) Pub. No.: US 2013/0106306 A1
(43) Pub. Date: May 2, 2013

(54) Lamp Unit and Luminaire

(71) Applicants: Hiromichi Nakajima, Yokosuka-shi (JP); Go Kato, Yokosuka-shi (JP); Shinichiro Matsumoto, Yokosuka-shi (JP); Masahiko Kamata, Yokosuka-shi (JP)

(72) Inventors: Hiromichi Nakajima, Yokosuka-shi (JP); Go Kato, Yokosuka-shi (JP); Shinichiro Matsumoto, Yokosuka-shi (JP); Masahiko Kamata, Yokosuka-shi (JP)

(73) Assignee: TOSHIBA LIGHTING & TECHNOLOGY CORPORATION, Yokosuka-shi (JP)

(21) Appl. No.: 13/599,172

(22) Filed: Aug. 30, 2012

(30) Foreign Application Priority Data
Oct. 31, 2011 (JP) 2011-239811

(51) Int. Cl. H05B 37/02

(52) U.S. Cl. 315/291

(57) ABSTRACT

According to one embodiment, a lamp unit includes a housing having a cap, a light source arranged in the housing, and a lighting device arranged in the housing and configured to supply an electric power to the light source. The lighting device includes a main substrate formed into an annular shape having an opening to allow light from the light source to pass through. A filter circuit portion, a power conversion circuit portion, and a control circuit portion are provided in sequence in respective areas on the main substrate along the circumferential direction. In at least one of the areas on the main substrate, a sub-substrate to be electrically connected to the main substrate is provided so as to extend upright.

INCORPORATION BY REFERENCE The present invention claims priority under 35 U.S.C. §119 to Japanese Patent Application No. 2011-239811 filed on Oct. 31, 2011. The content of the application is incorporated herein by reference in their entirety.

### FIELD

Embodiments described herein relate generally to a lamp unit provided with a light source and a lighting device configured to supply power to the light source and a luminaire using this lamp unit.

### BACKGROUND

In the related art, there is a flat-type lamp unit using, for example, a cap of GX53 type. Arranged in the lamp unit are a light source in a housing having the cap and a lighting device configured to supply power to the light source.

The lighting device includes various circuits configured to rectify an AC power input from the cap, convert the rectified power supply voltage to a predetermined output power and output the converted output power to the light source and turn ON the light source, and the various circuits are provided on a single substrate.

However, the lighting device arranged in the lamp unit is limited in surface area of the substrate depending on a storage space in the interior of the housing, and hence efficient arrangement of the various circuits on the substrate is important. Also, since the surface area of the substrate is limited, addition of functions such as dimming which may require additional surface area of the substrate may not be accommodated easily.

An exemplary embodiment is intended to provide a luminaire which achieves efficient arrangement of circuits on a substrate and securement of a surface area of the substrate, and a luminaire using the lamp unit.

### BRIEF DESCRIPTION OF THE DRAWINGS

FIG. 1 is a front view of a lighting device of a lamp unit illustrating an embodiment;

FIG. 2 is a circuit diagram of the lighting device;

FIG. 3 is a cross-sectional view of a luminaire using the lamp unit in FIG. 1 and an apparatus body; and

FIG. 4 is a perspective view of an exploded state of the lamp unit and the apparatus body of the luminaire in FIG. 3.

### DETAILED DESCRIPTION

A lamp unit includes a housing having a cap, a light source arranged in the housing, and a lighting device arranged in the housing and configured to supply an electric power to the light source. The lighting device includes a main substrate formed into an annular shape having an opening to allow light from the light source to pass through. A filter circuit portion, a power conversion circuit portion, and a control circuit portion are provided in sequence in respective areas on the main substrate along the circumferential direction. In at least one of the areas on the main substrate, a sub-substrate to be electrically connected to the main substrate is provided so as to extend upright.

In this configuration, the filter circuit portion, the power conversion circuit portion and the control circuit portion are provided in the respective areas in sequence along the circumferential direction of the main substrate and the sub-substrate to be electrically connected to the main substrate is provided so as to extend upright at least in any one of the areas of the main substrate and hence the opening is provided at a center of the main substrate. Accordingly, even though the surface area of the main substrate is limited, efficient arrangement of the circuits of the lighting device may be arranged, and securement of the surface area of the substrate is expected.

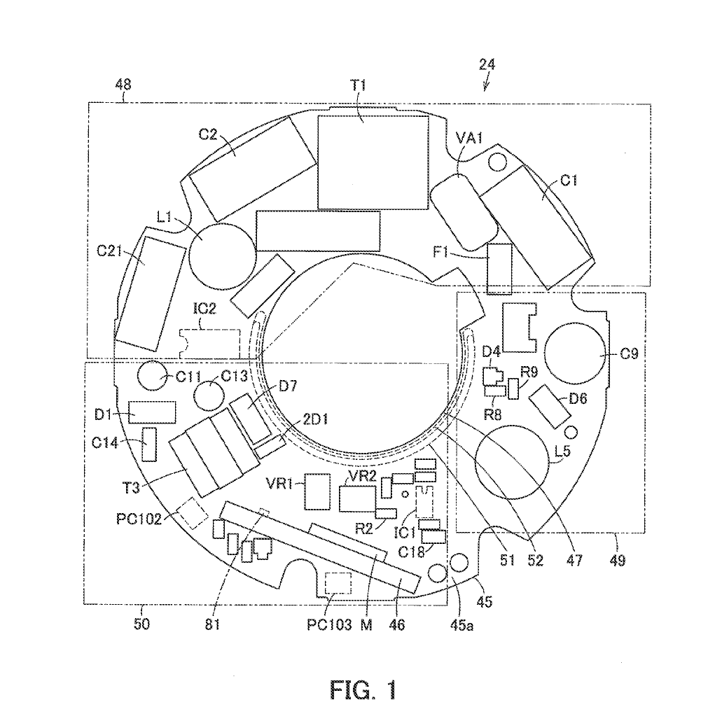

Referring now to FIG. 1 to FIG. 4, an embodiment will be described.

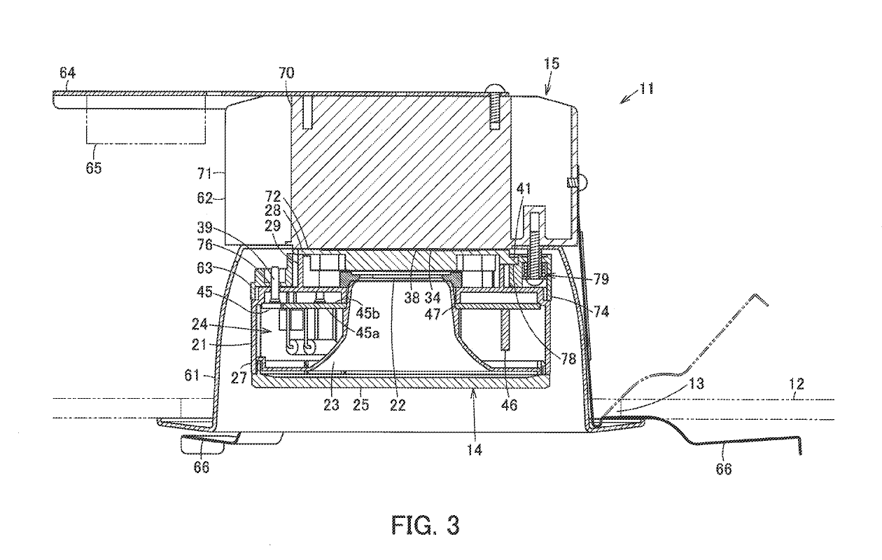

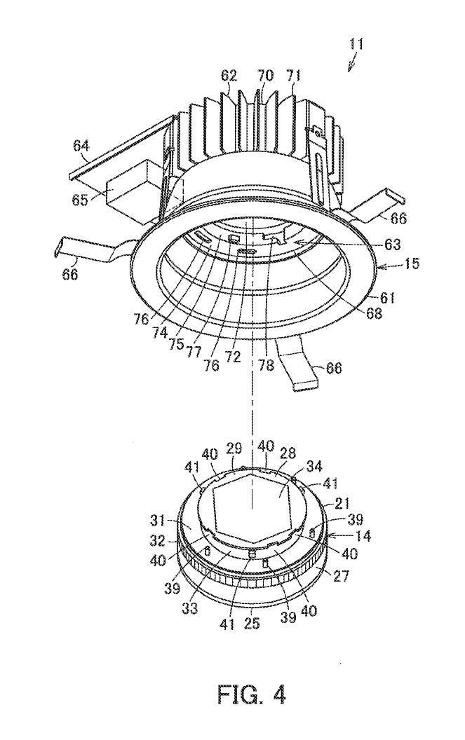

As shown in FIG. 3 and FIG. 4, a luminaire 11 is a recessed luminaire such as downlights, and is installed in a state of being embedded into a circular recess 13 provided in a ceiling panel 12. The luminaire 11 includes a flat-type lamp unit 14 and an apparatus body 15 in which the lamp unit 14 is arranged. The vertical directional relationship between the lamp unit 14 and the apparatus body 15 will be expressed with reference to the state of installation of the luminaire 11 to the ceiling panel 12.

The lamp unit 14 is provided with a flat cylindrical typed housing 21. Accommodated in the housing 21 are a light source 22, a reflecting member 23 and a lighting device 24, and a translucent cover 25 is assembled to a lower surface of the housing 21.

The housing 21 includes a cylindrical case 27, and a disk-shaped cap member 28 to be assembled to an upper surface of the case 27. The upper portion side of the case 27 and the cap member 28 constitute a cap 29 having a predetermined standard size.

The case 27 is formed of a synthetic resin having insulating properties and includes an end plate portion 31 on the upper surface, a cylindrical peripheral surface portion 32 projecting downward from a peripheral portion of the end plate portion 31, and a cylindrical cylindrical portion 33 projecting upward from an upper surface of the end plate portion 31. A lower surface of the case 27 is opened.

The cap member 28 is formed of a metallic material such as, for example, aluminum die-casting into a disk shape. The diameter of the cap member 28 is larger than the diameter of the cylindrical portion 33 of the case 27, and a peripheral portion of the cap member 28 projects with respect to an outer peripheral surface of the cylindrical portion 33 of the case 27. A thermal conductive sheet 34 is mounted on an upper surface of the cap member 28.

A plurality of lamp pins 39 project from the upper surface of the case 27. In the embodiment, there are five of the lamp pins 39 including two lamp pins 39 for power supply input, two lamp pins 39 for inputting dimming signals, and one lamp pin 39 for connecting an earth.

A plurality of mounting error preventing grooves 40 are notched on the peripheral portion of the cap member 28 and a plurality of mounting keys 41 are formed to project respectively at positions between the mounting error preventing grooves 40 adjacent in the circumferential direction.

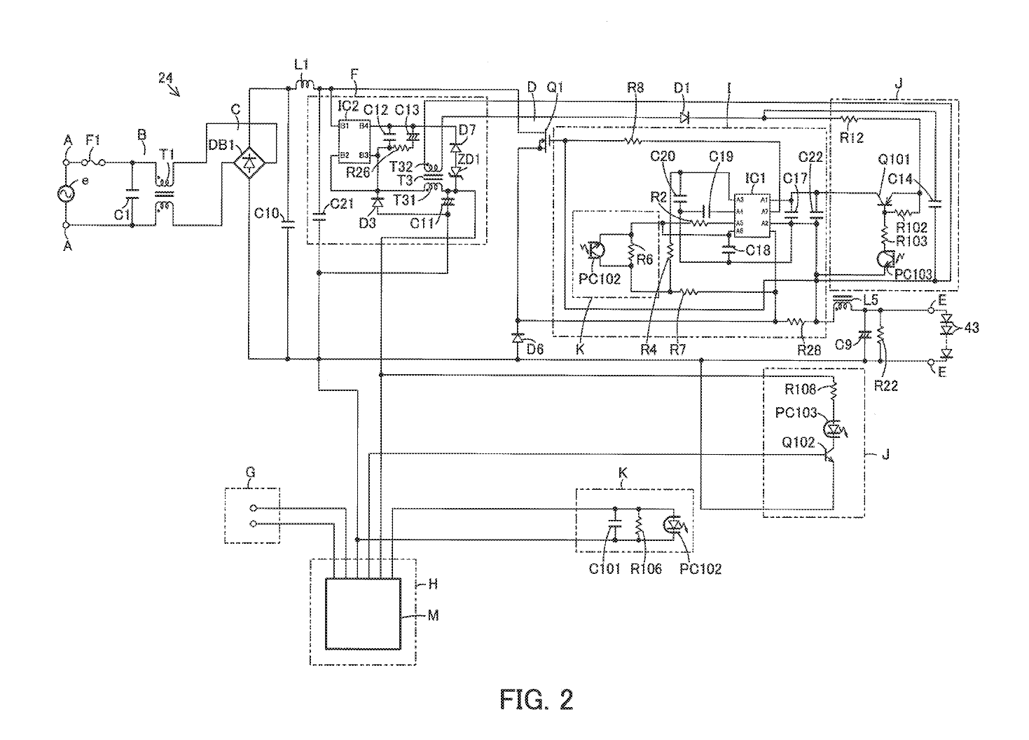

The light source 22 is assembled to a lower surface of the cap member 28 in tight contact thereto. The light source 22 employs a semiconductor light-emitting element such as an LED element. or an EL element. In the embodiment, an LED element 43 is employed as the semiconductor light-emitting element (see FIG. 2), and a COB (Chip On Board) system having a plurality of LED elements mounted on a substrate is employed. A system of mounting a plurality of SMD (Surface Mount Device) packages having connection terminals and having the LED elements mounted thereon on the substrate may be employed.

The reflecting member 23 is formed of a synthetic resin having insulating properties into a cylindrical shape widening downward.

Subsequently, the lighting device 24 is provided with a circuit configuration illustrated in FIG. 2.

The lighting device 24 is configured to turn ON the plurality of LED elements 43 connected in series. The lighting device 24 includes a power supply input unit A that receives an input of an AC power supply e, a filter circuit B connected to the power supply input unit A, a rectification circuit C connected to the filter circuit B and configured to rectify the AC power supply e, a power conversion circuit D as a main circuit configured to convert the power supply voltage rectified by the rectification circuit C into a predetermined output power that turns on the LED elements 43, and an output unit E which is an output portion of the power conversion circuit D and to which the LED elements 43 are connected.

The lighting device 24 further includes a power circuit F that supplies a power for control, a dimming signal input unit G that inputs a dimming signal, a first control circuit H as a dimming control circuit configured to process the dimming signal, a second control circuit I as a control circuit that controls the power conversion circuit D, an operation control circuit J configured to control ON and OFF of the second control circuit I, and a dimming operation circuit K configured to cause the second control circuit I to perform the dimming operation by the control of the first control circuit H.

Then, the power supply input unit A allows an input of the AC power supply e within a range from 100V to 242V, for example.

In the filter circuit B, a capacitor C1 and a transformer T1 are connected to the power supply input unit A via a fuse F1.

The rectification circuit C includes a full-wave rectifier DB1. A capacitor 010 is connected to an output end of the full-wave rectifier DB1 in parallel.

The power conversion circuit D is a step-down chopper circuit, and a field-effect transistor Q1 which is MOSFET as a switching element, a resistance R28, an inductor L5, and the LED elements 43 at the output unit B are connected to the output end of the full-wave rectifier DB1 via an inductor L1. A resistance R22 and an electrolytic capacitor C9 are connected to the output unit E in parallel.

A cathode of a diode D6 is connected between a source of the field-effect transistor Q1 and the inductor L5, and an anode of the diode D6 is connected to ground potential sides of the LED elements 43 and the electrolytic capacitor C9. The diode D6 has a function to discharge energy accumulated in the inductor L5 via the LED elements 43 and the electrolytic capacitor C9 when the field-effect transistor Q1 is in an OFF state.

In the power circuit F, a capacitor C21 is connected to the output end of the full-wave rectifier DB1 on the high potential side via the inductor L1 and the ground potential side of the capacitor C21 is connected to the first control circuit H. A terminal B1 of a control unit IC2 is connected to the inductor L1, and a terminal B2 of the control unit IC2 is connected to the first control circuit H via a primary winding T31 of a transformer T3. A cathode of a diode D3 and an end of an electrolytic capacitor C11 are connected to both ends of the primary winding T31. An anode of the diode D3 and the other end of the electrolytic capacitor C11 are connected between the capacitor C21 and the ground potential side of the full-wave rectifier DB1.

A direct circuit of a capacitor C12, an electrolytic capacitor C13 and a resistance R26 are connected between a terminal B4 and a terminal B3 of the control unit IC2 in parallel. and a cathode of a diode D7 is connected, to the electrolytic capacitor C13. An anode of a Zener diode ZD1 is connected to an anode of the diode D7, and a cathode of the Zener diode ZD1 is connected to the electrolytic capacitor C11.

Then, the control unit IC2 is, for example, an IPD (Intelligent Power Device), includes a switching element in the interior thereof, converts a power supply voltage input to the control unit IC2 by a switching operation of the switching element into a predetermined first control power supply, and the first control power supply common to the ground potential of the power conversion circuit D is supplied to the first control circuit H through the primary winding T31 of the transformer T3.

When the first control power supply flows to the primary winding T31, a second control power supply is induced in a secondary winding T32, which is insulated and magnetically coupled with respect to the primary winding T31 of the transformer T3, and hence the second control power supply having an arbitrary ground potential different from the ground potential of the power conversion circuit D is supplied to the second control circuit I via the operation control circuit J.

A dimming signal is input to the dimming signal input unit G from a dimmer installed outside.

The first control circuit H is provided with a micro computer N, which is operated by receiving a supply of the first control power supply common to the ground potential of the power conversion circuit 17 from the power circuit F. The micro computer M is configured to perform processing according to the dimming signal from the dimmer, and controls ON and OFF of the operation of the second control circuit I by outputting an ON-OFF signal to the operation control. circuit J, or controls the dimming operation of the second control circuit I by generating a dimming control signal such as a PWM dimming control signal according to the dimming signal and outputting the generated dimming control signal to the dimming operation circuit K.

The second control circuit I includes a control unit IC1, and the second control power supply having the arbitrary ground potential different from the ground potential of the power conversion circuit D is supplied from the power circuit F to a VCC terminal A1 of the control unit IC1 via the operation control circuit J. A GND terminal A2 is connected to an end of the inductor L5 on the side of the field-effect transistor Q1, and the potential at a center point of the power conversion circuit D is determined as the ground potential. Capacitors C17 and C22 are connected between a VCC terminal A1 and a GND terminal A2 in parallel.

A terminal A3 of the control unit IC1 is connected between the cathode of the diode D6 and the inductor L5 via resistances R4 and R7 and a detection voltage according to an output current from the power conversion circuit D is input thereto.

A terminal A4 of the control unit IC1 is connected to a gate of the field-effect transistor Q1 via a capacitor C19.

A capacitor C20 is connected between the terminal A3 and the GND terminal A2 of the control unit IC1, a resistance R2 is connected between a terminal A5 and the dimming operation circuit K, and a capacitor C18 is connected between a terminal A6 and the GND terminal A2.

A terminal A7 of the control unit IC1 is connected to the gate of the field-effect, transistor Q1 via a resistance R8.

Then, the control unit IC1 includes an operational amplifier in the interior thereof. A predetermined reference voltage is input to one of input terminals of the operational amplifier, and a detection voltage according to the output current from the power conversion circuit D is input to the other input terminal from the terminal A3. The control unit IC1 then outputs a current according to the difference between the reference voltage and the detection voltage from the terminal A4, and performs a feedback control of ON and OFF of the field-effect transistor Q1 so that the detection voltage input to the terminal A3 is kept constant. In other words, the terminal A3 is an input terminal of the operational amplifier, and the terminal A4 is an output terminal of the operational amplifier.

In the operation control circuit J, one end of the secondary winding T32 of the transformer T3 of the power circuit F is connected to the VCC terminal A1 of the control unit 101 via a diode D1 and a resistance R12, and the transistor Q101 and the other end of the secondary winding T32 is connected to the GND terminal A2 of the control unit 101. A capacitor C14 is connected between both ends of the secondary winding T32. A resistance R102 is connected between an emitter and a base of a transistor Q101. The base of the transistor Q101 is connected to the GND terminal A2 of the control unit IC1 via a resistance R103 and a photo transistor of a photo coupler PC103 as an operation control insulation transmitting element.

A series circuit of a resistance R108, a photodiode of the photo coupler PC103, and a collector and an emitter of a transistor Q102 is connected between the primary winding T31 side of the transformer T3 of the power circuit F configured. to supply the first control power supply and the ground potential of the power conversion circuit D. A base of the transistor Q102 is connected to a terminal that outputs ON-OFF signal from the micro computer M of the first control circuit H.

Accordingly, the transistor Q102 is turned ON and OFF according to the ON-OFF signal from the micro computer N and the photo coupler PC103 is turned ON and OFF. When the photo coupler PC103 is in the OFF state, the transistor Q101 is turned OFF, and. the second control power supply from the power circuit F is supplied to the second control circuit I. In contrast, when the photo coupler PC103 is in the ON state, the transistor Q101 is turned ON and the supply of the second control power supply to the second control circuit I is stopped.

The dimming operation circuit K includes a photo coupler PC102 as a dimming insulation transmitting element, and a photodiode of the photo coupler PC102 is connected between the terminal that outputs the dimming signal from the micro computer M of the first control circuit H and the ground potential of the power conversion circuit D. A capacitor C101 and a resistance R106 are connected in parallel to the photodiode of the photo coupler PC102.

A resistance 26 is connected in parallel to a collector and an emitter of the photo transistor of the photo coupler PC102, one end of the resistance 26 is connected to a terminal A5 of the control unit IC1 via a resistance R2 and the other end of the resistance R6 is connected between the resistance R4 and the resistance 27 of the second control circuit I.

A circuit operation of the lighting device 24 will be described.

The input AC power supply e is rectified by the full-wave rectifier DB1, and the rectified power supply voltage is supplied to the power circuit F and the power conversion circuit D.

When the control unit 102 of the power circuit F to which the power supply voltage is supplied starts operation, the switching element of the control unit 102 performs a switching operation, creates the first control power supply common to the ground potential of the power conversion circuit D, and supplies the created first control power supply to the first control circuit H via the primary winding T31 of the transformer T3. When the first control power supply flows to the secondary winding T32, which is insulated and magnetically coupled with respect to the primary winding T31 of the transformer T3, the second control power supply is induced, and the second control power supply having the arbitrary ground potential different from the ground potential of the power conversion circuit D is supplied to the operation control circuit J.

When the first control circuit H which receives a supply of the first control power supply starts operation, the photo coupler PC103 of the operation control circuit J is turned OFF by the operation signal from the micro computer M, and the transistor Q101 of the operation control circuit J is turned OFF, so that the second control power supply is supplied to the second control circuit I via the operation control circuit J.

When the second control circuit I which receives a supply of the second control power supply starts operation, the control unit IC1 turns ON and OFT the field-effect transistor Q1 of the power conversion circuit D.

When the field-effect transistor Q1 is turned ON, an electric current flows to the electrolytic capacitor C9 via the field-effect transistor Q1, the resistance R28, and the inductor L5. When a charging voltage of the electrolytic capacitor 09 is increased to a level equal to or higher than a forward voltage of the LED elements 43, an electric current flows to the LED elements 43, and the LED elements 43 are turned ON.

When the field-effect transistor Q1 is turned OFF, energy accumulated in the inductor L5 is released from a closed circuit of the electrolytic capacitor C9, the LED elements 43, and the diode D6. The LED elements 43 are turned ON by the electric current flowing by the release of the energy.

The field-effect transistor Q1 performs a high-frequency switching operation by ON and OFF of the field-effect transistor Q1, and the LED elements 43 are turned ON.

The control unit 102 performs the feedback control of the ON-OFF of the field-effect transistor Q1 so that the output current of the power conversion circuit D becomes constant. on the basis of the detection voltage according to the output current of the power conversion circuit D.

The micro computer N of the first control circuit H which receives an input of the dimming signal from the dimmer outputs a dimming control signal corresponding to the dimming signal to the dimming operation circuit K, and sends the dimming control signal to the second control circuit I via the photo coupler PC102. The second control circuit I controls ON-OFF of the field-effect transistor Q1 according to the received dimming control signal and dims the LED elements 43.

In dimming control, there is a waiting mode in which the power conversion circuit D is stopped when the dimming signal. falls within a range exceeding predetermined conditions. In the waiting mode, the photo coupler PC103 is turned ON by the output of a stop signal from the micro computer M to the operation control circuit J, and the transistor Q102 of the operation control circuit J is turned ON and a supply of the second control power supply to the second control circuit I is stopped. Therefore, the power conversion circuit D which does not receive the supply of the second control power supply stops, and hence the LED elements 43 are turned OFF.

The lighting device 24 having a circuit configuration as described above is arranged in the housing 21 in an annular space between the end plate portion 31 and the peripheral surface portion 32 of the case 27 and the reflecting member 23 and the translucent cover 25 as illustrated in FIG. 3.

As illustrated in FIG. 1 and FIG. 3, the lighting device 24 includes a main substrate 45 and a sub-substrate 46. The main substrate 45 is formed into an annular shape having a circular opening 47 at the center, and discrete components using mainly lead wires are mounted on a mounting surface 45a as a first surface, and mainly chip components are mounted on a pattern surface 45b as a second surface.

The main substrate 45 is formed with areas of a filter circuit portion 48, a power conversion circuit portion 49 and a control circuit portion 50 formed in sequence along the circumferential direction. In the area of the filter circuit portion 48, the power supply input unit A, the filter circuit B, and the rectification circuit C are mainly provided. In the area of the power conversion circuit portion 49, the power conversion circuit C and the output unit E are mainly provided. In the area of the control circuit portion 50, the power circuit F, the dimming signal input unit G, the second control circuit I, the operation control circuit J and the dimming operation circuit K are mainly provided.

The sub-substrate 46 is provided so as to extend upright in the area of the control circuit portion 50 and is electrically connected to the main substrate 45. The main substrate 45 and the sub-substrate 46 are connected by a connecting measure such as soldering or an adhesive agent so that mounting surfaces thereof are orthogonal to each other. The sub-substrate 46 may be electrically connected to the main substrate 45 and mechanically held by providing a connector for inserting the substrate on the main substrate 45 and inserting the sub-substrate 46 into the connector.

The sub-substrate 46 is provided with the first control circuit H configured to process the dimming signal, whereby the dimming signal input from the main substrate 45 is processed and the processed signal is output to the main substrate 45. The sub-substrate 46 is oriented in such a manner that a first surface faces toward the center of the main substrate 45, and a second surface faces radially outward of the main substrate 45. Components such as the micro computer M are mounted on the first surface of the sub-substrate 46.

A high-potential pattern 51 is provided along an inner peripheral, side of one of the mounting surface 45a or the pattern surface 45b of the main substrate 45, and a ground potential pattern 52 is provided along an inner peripheral side of a surface opposite the surface of the main substrate 45 where the high-potential pattern 51 is formed. Therefore, the high-potential pattern 51 and the ground potential pattern 52 are provided so as to oppose each other by the intermediary of the main substrate 45. The high-potential pattern 51 is a pattern on the high potential side extending from the high potential side of the full-wave rectifier DB1 of the filter circuit portion 48 to the field-effect transistor Q1 and the inductor L5 of the power conversion circuit portion 49. The ground potential pattern 52 is a pattern on the ground potential side of a main circuit.

The components which constitute the lighting device 24 include components susceptible to temperature characteristics such as the electrolytic capacitor C9 and the photo couplers PC102 and PC103. The components which are susceptible to the temperature characteristics are arranged at a position deviated toward an outer periphery of the main substrate 45.

Subsequently, as illustrated in FIG. 4, the apparatus body includes a reflecting member 61 opening downward so as to be gradually widened, a thermal radiating member 62 mounted on an upper portion of the reflecting member 61, a socket 63 assembled to a lower portion of the thermal radiating member 62, a terminal base 65 assembled to an upper portion of the thermal, radiating member 62 by a mounting panel 64, and a plurality of mounting springs 66 assembled to a periphery of the thermal radiating member 62 for attachment to a ceiling.

Formed on a top portion of the reflecting member 61 is a circular opening 68 which exposes a lower surface of the thermal radiating member 62.

The thermal radiating member 62 is formed of a material superior in heat radiating properties such as a metal like aluminum die-casting or ceramics. The thermal radiating member 62 includes a column-shaped base portion 70 and a plurality of thermal radiating fins 71 projecting radially from a periphery of the base portion 70. A lower surface of the base portion 70 is formed with a planar contact surface 72 exposed from the opening 68 of the reflecting member 61.

The socket 63 includes a socket body 74 formed of a synthetic resin having insulating properties into an annular shape and a plurality of terminals, not shown, arranged in the socket body 74.

Formed on the inside of the socket body 74 is a circular insertion port 75 where the cap member 28 of the lamp unit 14 is inserted. Formed. on a lower surface of the socket body 74 along the circumferential direction thereof are a plurality of elongated connecting holes 76 for allowing insertion of the plurality of lamp pins 39 of the lamp unit 14. Respective terminals are arranged on upper sides of the respective connecting holes 76 and the respective lamp pins 39 of the lamp unit 14 inserted into the respective connecting holes 76 are electrically connected to the respective terminals. Formed on an inner peripheral surface of the socket body 74 are a plurality of mounting error preventing keys 77 projecting therefrom and a plurality of mounting grooves 78. The socket 63 is supported by the thermal radiating member 62 via a supporting mechanism 79 configured to presses the cap member 28 against the contact surface 72 via the thermal conductive sheet 34 by the cap 29 of the lamp unit 14 mounted in the socket 63.

In sequence to mount the lamp unit 14 in the apparatus body 15, the plurality of mounting error preventing grooves 40 of the cap member 28 are aligned with the plurality of mounting error preventing keys 77 of the socket 63 and the cap member 28 of the lamp unit 14 is inserted into the insertion port 75 of the socket 63.

Then, a cap projecting portion 36 is inserted into the insertion port 75 of the socket 63 to a position of insertion where a distal end surface 38 (the thermal conductive sheet 34) of the cap projecting portion 36 comes into abutment with the contact surface 72 of the thermal radiating member 62. At this time, the respective lamp pins 39 projecting from the cap 29 are inserted into the respective connecting holes 76 of the socket 63. By rotating the lamp unit 14 in the mounting direction by a predetermined angle, the respective mounting keys 41 of the can member 28 are caught by the respective mounting grooves 78 of the socket 63 and the lamp unit 14 is attached to the socket 63. At this time, the respective lamp pins 39 are inserted into the respective connecting holes 76 of the socket 63 and are moved within the respective connecting holes 76, and the respective lamp pins 39 are electrically connected to the respective terminals arranged in the respective connecting holes 76.

As described above, since the lamp unit 14 is provided with the filter circuit portion 48, the power conversion circuit portion 49 and the control circuit portion 50 in the respective areas in sequence along the circumferential direction of the main substrate 45 and the main substrate 45 is provided with the sub-substrate 46 to be electrically connected to the main substrate 45 so as to extend upright, even though the surface area of the main substrate 45 is limited, efficient arrangement of the circuits of the lighting device 24 is achieved, and the surface area of the substrate is secured.

Also, by using the sub-substrate 46, the first control circuit H configured to process the dimming signal may be provided on the sub-substrate 46 and hence a dimming function may be added to the lighting device 24.

In this case, the sub-substrate 46 is configured to process the dimming signal input from the main substrate 45, and output the processed signal to the main substrate 45. Although a harness is used for connecting the dimming signal from the lamp pins 39 to the lighting device 24, the harness is connected to the dimming signal input unit G of the main substrate 45 instead of being connected directly to the sub-substrate 46. Accordingly, even when a force is applied on the harness at the time of assembly, a stress is not generated directly on the sub-substrate 46, so that the connecting state between the sub-substrate 46 and the main substrate 45 may be protected. The sub-substrate 46 having the micro computer M or the like which requires a sufficient insulating distance mounted thereon may be disposed apart from the harness or the like, so that the insulating distance is easily secured. in other words, when connecting the harness directly to the sub-substrate 46, securement of the insulating distance from the harness. on the sub-substrate 46 having a limited space is difficult. However, by connecting the harness to the main substrate 45 which allows securement of the space relatively easily, the insulating distance may be secured.

Also, by providing the high-potential pattern 51 along the inner peripheral side of the surface of the main substrate 45, the high-potential pattern 51. may be wired at a shortest distance, so that influence of a noise of the high-potential pattern 51 or transmission loss may be reduced.

in addition, by providing the ground potential pattern 52 alone the inner peripheral side of the surface opposite from the surface of the main substrate 45 on which the high-potential pattern Si is formed and providing the high-potential pattern 51 and the ground potential pattern 52 so as to oppose each other via the main substrate 45, the noise generated on the high-potential pattern 51 may be cancelled by the noise generated on the ground potential pattern 52, whereby the noise may be reduced.

Also, by arranging the components susceptible to the temperature characteristics from among the components which constitute the lighting device 24 at positions deviated toward the outer periphery of the main substrate 45, such components may be arranged apart from the light source 22 which generates heat, so that the influence of the heat from the light source 22 may be reduced. Accordingly, the operation of the components susceptible to the temperature characteristics is stabilized, and hence the lifetime may be elongated.

For reference, a temperature detection element 31 may be provided together with the micro computer M on the surface of the sub-substrate 46 facing the center of the main substrate 45. The temperature detection element 81 is capable of detecting abnormal temperature rise of the light source 22 due to the lack of heat radiation, for example, so that the output of the power conversion circuit D may be stopped by the first control circuit H or the output may be inhibited. When the micro computer M having a temperature detecting function is used, the same effects and advantages as the temperature detection element 91 are obtained by the micro computer H by directing the surface of the sub-substrate 46 on which the micro computer N is mounted toward the opening 47, that is, toward the light source 22.

The sub-substrate 46 may be provided so as to extend upright not only from the control circuit portion 50, but also from the filter circuit portion 48 or the power conversion circuit portion 49.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp unit comprising:
a housing having a cap;
a light source arranged in the housing; and
a lighting device arranged in the housing, including main substrate formed into an annular shape having an opening to allow light from the light source to pass through, the main substrate including a filter circuit portion, a power conversion circuit portion, and a control circuit portion provided in respective areas arranged in sequence along the circumference direction thereof, and also including a sub-substrate electrically connected to the main. substrate in at least one of the areas thereof so as to extend upright therefrom, and configured to supply power to the light source.

2. The unit according to claim 1, wherein the sub-substrate is provided so as to extend upright in the area of the control circuit portion, includes a dimming control circuit configured to process a dimming signal, processes the dimming signal input from the main substrate, and outputs the processed signal to the main substrate.

3. The unit according to claim 1, wherein a high-potential pattern is provided along an inner peripheral side of a first surface of the main substrate.

4. The unit according to claim 1, wherein a ground potential pattern is provided along an inner peripheral side of a second surface of the main substrate opposite the first surface.

5. The unit according to claim 1, wherein components susceptible to temperature characteristics from among components which constitute the lighting device are provided on an outer peripheral side of the main substrate.

6. The unit according to claim 1, wherein a surface of the sub-substrate faces toward the center of the main substrate, and the surface is provided with a temperature detecting element.

7. A luminaire comprising:
a lamp unit; and
an apparatus body on which the lamp unit is arranged, wherein
the lamp unit includes:
a housing having a cap;
a light source arranged in the housing; and
a lighting device arranged in the housing, including a main substrate formed into an annular shape having an opening to allow light from the light source to pass through, the main substrate including a filter circuit portion, a power conversion circuit portion, and a control circuit portion provided in respective areas arranged in sequence along the circumference direction thereof, and also including a sub-substrate electrically connected to the main, substrate in at least one of the areas thereof so as to extend upright therefrom, and configured to supply power to the light source.

8. The luminaire according to claim 7, wherein the sub-substrate is provided so as to extend upright in the area of the control circuit portion, includes a dimming control circuit configured to process a dimming signal, processes the dimming signal input from the main substrate, and outputs the processed signal to the main substrate.

9. The luminaire according to claim 7, wherein a high-potential pattern is provided along an inner peripheral side of a first surface of the main substrate.

10. The luminaire according to claim 7, wherein a ground potential pattern is provided along an inner peripheral side of a second surface of the main substrate opposite the first surface.

11. The luminaire according to claim 7, wherein components susceptible to temperature characteristics from among components which constitute the lighting device are provided on an outer peripheral side of the main substrate.

12. The luminaire according to claim 7, wherein a surface of the sub-substrate faces toward the center of the main substrate, and the surface is provided with a temperature detecting element.
